(19) United States
(12) Patent Application Publication
(10) Pub. No.: US 2026/0227806 A1
(43) Pub. Date: Aug. 6, 2026

(54) Muting Obstacle Detection for Autonomous Vehicles

(71) Applicant: Autonomous Solutions, Inc., Mendon, UT (US)

(72) Inventor: Taylor Bybee, Mendon, UT (US)

(73) Assignee: Autonomous Solutions, Inc., Mendon, UT (US)

(21) Appl. No.: 19/409,024

(22) Filed: Dec. 4, 2025

Related U.S. Application Data
(60) Provisional application No. 63/753,939, filed on Feb. 5, 2025.
(60) Provisional application No. 63/779,265, filed on Mar. 27, 2025.

(51) Int. Cl. G05D 1/80; G05D 1/622

(52) U.S. Cl. CPC G05D 1/80; G05D 1/622

(57) ABSTRACT

An autonomous vehicle is disclosed that includes a sensor array; an obstacle detection system configured to receive sensor data from the sensor array, a controller, a user interface configured to receive visual data from the camera system and to display the visual data from the camera system to an operator. The obstacle detection system may be configured to detect the presence of an obstacle based on the sensor data, and send out an inhibit signal to inhibit movement or start-up of the autonomous vehicle or to shut down the autonomous vehicle when an obstacle is detected. The controller may be configured to receive commands from an operator identifying or negating the presence of an obstacle; if the controller receives a command negating the presence of an obstacle, overriding the obstacle detection system and enabling movement of the autonomous vehicle.

### BACKGROUND

Autonomous vehicle systems typically have safety systems to enable safe autonomous use of the vehicle. Occasionally, those safety systems may create errors which may unnecessarily impede normal operation of the autonomous vehicle.

### SUMMARY

In some examples, an autonomous vehicle is disclosed that may include a sensor array including a camera system; an obstacle detection system configured to receive sensor data from the sensor array, a user interface configured to receive visual data from the camera system and to display the visual data from the camera system to an operator, wherein the obstacle detection system is further configured to: detect the presence of an obstacle based on the sensor data, and send out an inhibit signal to inhibit movement or start-up of the autonomous vehicle or to shut down the autonomous vehicle when an obstacle is detected; the autonomous vehicle further including a controller, in communication with the obstacle detection system and the user interface, the controller configured to: receive commands from an operator identifying or negating the presence of an obstacle; if the controller receives a command negating the presence of an obstacle, overriding the obstacle detection system and enabling movement of the autonomous vehicle.

In some examples, an autonomous vehicle, wherein the controller is configured to prompt the operator, through the user interface, to identify or negate the presence of an obstacle, if an obstacle is detected by the obstacle detection system.

In some examples, an autonomous vehicle, if the controller receives a command identifying the presence of an obstacle, taking no action.

In some examples, an autonomous vehicle, if the controller receives a command identifying or negating the presence of an obstacle, using the received command to train a learning model in the obstacle detection system.

In some examples, the obstacle detection system is configured to divide the sensor data representing a field of view of the sensor array into an occupancy grid such that, if an obstacle is detected, respective cells representing the area in which an obstacle was detected within the occupancy grid are identified as including an obstacle.

In some examples, the occupancy grid is overlaid on the user interface and the respective cells identified as including the obstacle are highlighted on the user interface to aid the user in identifying the obstacle.

In some examples, overriding the obstacle detection system includes clearing the occupancy grid.

In some examples, the obstacle detection system is configured to represent obstacles found in an object list, which is presented to the user on the user interface.

In some examples, an autonomous vehicle, wherein overriding the obstacle detection system includes clearing the object list.

In some examples the autonomous vehicle is a mower, a yard truck, a loader, a wheel loader, a track loader, a dump truck, a digger, a backhoe, a forklift, a harvester, a tractor, a land leveler, a scraper, a dozer, a trencher, a grader, a seeder, a fertilizer, or a harrow.

In some examples, a method of controlling an autonomous vehicle is disclosed. The method includes: receiving sensor data from a sensor array on the autonomous vehicle, including visual data from a camera system; detecting the presence of an obstacle based on the sensor data with an obstacle detection algorithm; sending out an inhibit signal to inhibit movement or start-up of the autonomous vehicle or to shut down the autonomous vehicle when an obstacle is detected; displaying the visual data to an operator; receive commands from an operator identifying or negating the presence of an obstacle; and if a command negating the presence of an obstacle is received, overriding the obstacle detection algorithm to enable movement of the autonomous vehicle.

In some examples, when the obstacle is detected, prompting a user to identify or negate the presence of the obstacle.

In some examples, if a command identifying the presence of an obstacle is received, taking no further action.

In some examples, if a command identifying or negating the presence of an obstacle is received, using the received command to train a learning model in the obstacle detection algorithm for detecting the obstacles.

In some examples, wherein sensor data is represented in an occupancy grid such that, if an obstacle is detected, respective cells representing the area in which an obstacle is detected within the occupancy grid are identified as including an obstacle.

In some examples, the method includes overlaying the occupancy grid on the user interface and highlighting the respective cells determined to include an obstacle on the user interface to aid the user in identifying the obstacle.

In some examples, the method includes overriding the obstacle detection algorithm includes clearing the occupancy grid.

In some examples, an obstacle detection is represented to the user as an object list, if an obstacle is detected, to aid the operator in identifying the obstacles.

In some examples, the method includes overriding the obstacle detection algorithm includes clearing the object list.

In some examples, a method, wherein the autonomous vehicle is a mower, a yard truck, a loader, a wheel loader, a track loader, a dump truck, a digger, a backhoe, a forklift, a harvester, a tractor, a land leveler, a scraper, a dozer, a trencher, a grader, a seeder, a fertilizer, or a harrow.

In some examples, an autonomous vehicle is disclosed that includes: a sensor array including a camera system; an obstacle detection system configured to receive sensor data from the sensor array and to divide the sensor data representing a field of view of the sensor array into an occupancy grid such that, if an obstacle is detected within the field of view, respective cells representing the area in which an obstacle was detected within the occupancy grid are identified as including an obstacle, a user interface configured to receive visual data from the camera system and to display the visual data from the camera system to an operator, wherein the obstacle detection system is further configured to: detect the presence of an obstacle within the occupancy grid based on the sensor data, and send out an inhibit signal to inhibit movement or start-up of the autonomous vehicle or to shut down the autonomous vehicle when an obstacle is detected; the autonomous vehicle further including a controller, in communication with the obstacle detection system and the user interface, the controller configured to: prompt the operator, through the user interface, to identify or negate the presence of an obstacle, if an obstacle is detected by the obstacle detection system; receive commands from an operator identifying or negating the presence of an obstacle; if the controller receives a command negating the presence of an obstacle, overriding the obstacle detection system, by clearing the occupancy grid, and enabling movement of the autonomous vehicle.

### BRIEF DESCRIPTION OF THE FIGURES

FIG. 1 schematically shows an isometric view of an example autonomous vehicle.

FIG. 2 illustrates a block diagram of an example autonomous vehicle communication system of the present disclosure.

FIG. 3 is a flow chart of an example process for controlling the autonomous vehicle.

FIG. 4 is a sideview of an autonomous tractor.

FIG. 5 is a sideview of an autonomous mower.

FIG. 6 is a block diagram of an example computational system (or controller).

### DETAILED DESCRIPTION

Systems and/or methods are disclosed for an autonomous vehicle and a method of controlling an autonomous vehicle. Some embodiments may include determining the presence of an obstacle in the vicinity of an autonomous vehicle, sending an inhibit signal to inhibit movement or start-up of the autonomous vehicle, or to shut down the autonomous vehicle, an operator manually confirming or negating the presence of the obstacle, and where the presence of an obstacle is negated, overriding the inhibit signal.

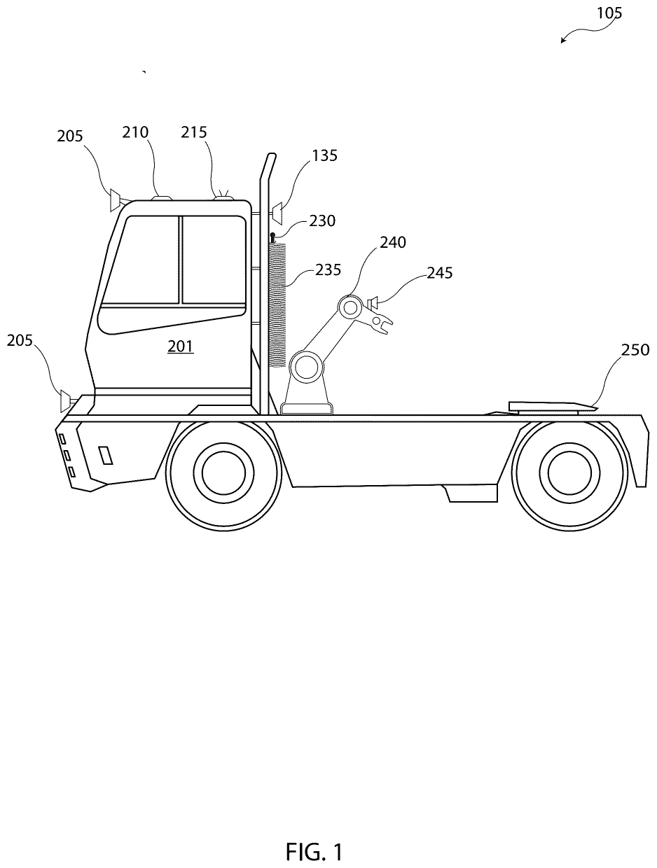

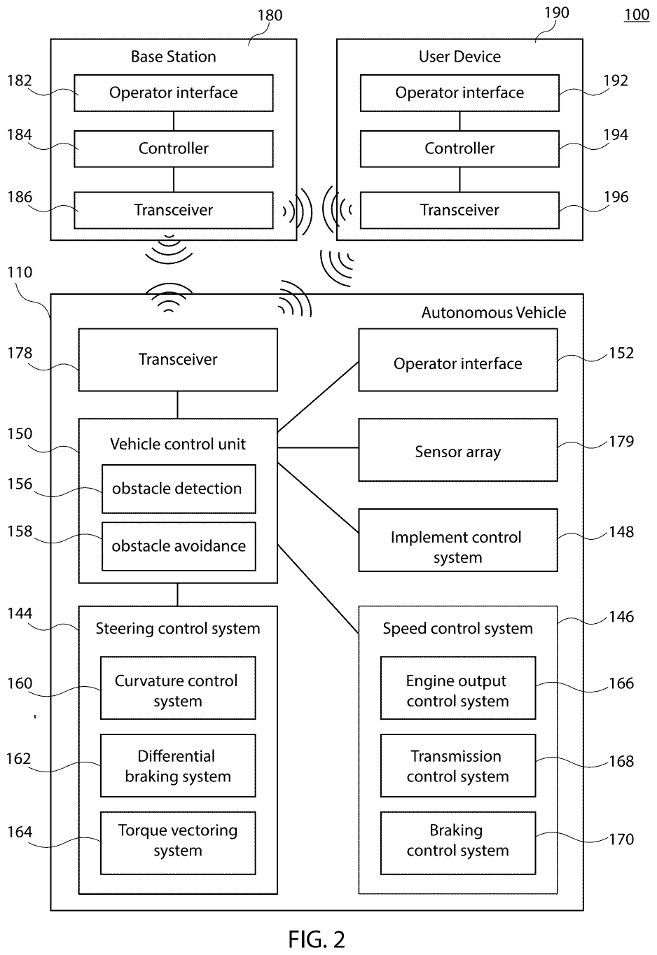

FIG. 1 shows an autonomous yard truck 105 which may be any type of autonomous yard truck. The autonomous yard truck 105 includes a cab 201 that may be used to drive the autonomous yard truck 105 manually. The autonomous yard truck 105 may include one or more controllers as described with reference to FIG. 2. The autonomous yard truck 105 may also include a brake system, an engine, a transmission, steering, etc.

In some embodiments, the autonomous yard truck 105 may include a sensor array that includes sensors 205 disposed at various locations on the autonomous yard truck 105 such as, for example, on the cab 201, bumper, housing, frame, etc. The sensors 205 may include infrared sensors, ultrasonic sensors, magnetic sensors, radar sensors, Lidar sensors, terahertz sensors, sonar sensors, a camera system including one or more cameras, etc. The cameras may be arranged to be front-facing to provide visual data of the front and/or front sides of the autonomous yard truck 105, rear-facing to provide visual data of the rear and/or rear sides of the autonomous yard truck 105, and/or internally within the cab 201 to provide visual data of an operator seat within the cab 201. The cameras of the camera system may comprise a fish-eye lens to capture a wider field of view.

In some embodiments, the autonomous yard truck 105 may include a spatial locating device (or GPS) antenna 210. In some embodiments, the autonomous yard truck 105 may include a transceiver antenna 215.

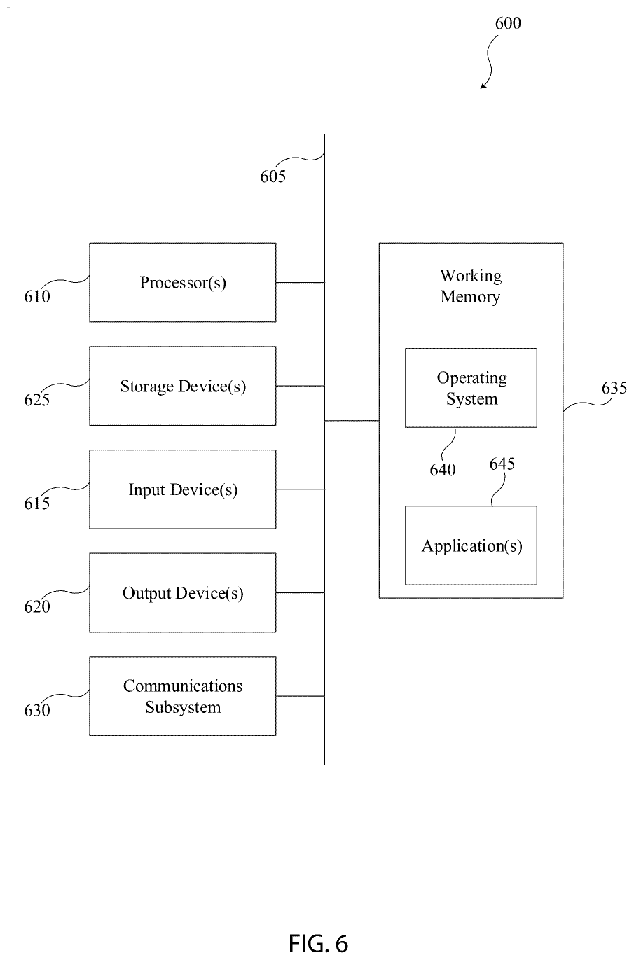

FIG. 2 is a block diagram of a communication and control system 100 that may be utilized in conjunction with the systems and methods of the disclosure. All or some of the components of control system 100 may or may not be included in an autonomous vehicle in any combination such as, for example, the autonomous yard truck 105, the autonomous tractor 400, and the autonomous mower 500. All or some of the components of control system 100 may be included in an autonomous vehicle or a remote system in any combination. The communication and control system 100 may include a vehicle control unit 150 which may be mounted on an autonomous vehicle 110, such as the autonomous yard truck 105 of FIG. 1. In other examples, the autonomous vehicle 110 may include any agricultural or construction machinery including for example a loader, wheel loader, track loader, dump truck, digger, backhoe, forklift, harvester, tractor, land leveler, scraper, dozer, trencher, grader, mower, seeder, fertilizer, and harrow etc. The autonomous vehicle 110 may have an implement or attachment connected to it, such as a disc harrow, a bucket, a shovel, a blade, a thumb, a dump bed, a plow, an auger, a trencher, a scraper, a broom, a hammer, a grapple, forks, boom, spears, a cutter, a wrist, a tiller, a rake, a cultivator, a chisel, a mower, a grader, a harvester, a rake, a rock picker, a rotavator, a ditcher, a dozer blade, a backhoe, an excavator, a disc plow, a seeder, a fertilizer etc. The communication and control system 100, for example, may include any or all components of computational unit 600 shown in FIG. 6.

The communication and control system 100, for example, may include a sensor array 179. The sensor array 179 of the autonomous vehicle 110 may include any of the same sensors 205 as the sensor array of the autonomous yard truck 105. The sensor array 179, for example, may facilitate determination of condition(s) of the autonomous vehicle 110 and/or the work area. For example, the sensor array 179 may include one or more sensors (e.g., infrared sensors, ultrasonic sensors, magnetic sensors, tachometer, radar sensors, Lidar sensors, terahertz sensors, sonar sensors, wheel encoders, cameras, etc.) that monitor a rotation rate of a respective wheel or track and/or a ground speed of the autonomous vehicle 110. The sensors may also monitor operating levels (e.g., temperature, fuel level, etc.) of the autonomous vehicle 110. Furthermore, the sensors may monitor conditions in and around the work area, such as temperature, weather, wind speed, compass, humidity, and other conditions. The sensors of the sensor array 179, for example, cameras, Lidar sensors, radar sensors, sonar sensors, infrared sensors, may enable detection of physical obstacles in the work area, such as a parking stall, a material stall, accessories, other vehicles, obstacles, people, environmental features, or other obstacle(s) that may be in the area surrounding the autonomous vehicle 110.

The sensor array 179, for example, may include a velocity sensor which may include one or more of an inertial measurement unit, a compass, a GPS sensor, a wheel encoder, a tachometer, a camera, a radar, etc. The sensor array 179, for example, may also include a steering angle sensor. The velocity sensor, for example, may produce velocity data. Velocity data may include speed and/or bearing. Velocity data, for example, may also include steering angular rate.

The autonomous vehicle 110 may include a steering control system 144 that may control a direction of movement of the autonomous vehicle 110. The steering control system 144, for example, may include any or all components of computational unit 600 shown in FIG. 6.

The autonomous vehicle 110, for example, may include a speed control system 146 that controls the speed, acceleration, and deceleration of the autonomous vehicle 110. The speed control system 146, for example, may control the speed of the autonomous vehicle 110 based on map data, control algorithms, obstacle detection, start and/or stop points, input from a base station 180, etc. The speed control system 146, for example, may include any or all components of computational unit 600 shown in FIG. 6.

The autonomous vehicle 110, for example, may include an implement control system 148 that may control operation of an implement towed by the autonomous vehicle 110 or integrated within the autonomous vehicle 110 or coupled to the autonomous vehicle 110. The implement control system 148 may, for example, include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 148, for example, may include any or all components of computational unit 600 shown in FIG. 6.

The autonomous vehicle 110, for example, may include an obstacle detection system 156 which may detect obstacles around the vicinity of the autonomous vehicle 110. The obstacle detection system 156 may detect obstacles using inputs from, for example, the sensor array 179. Additionally or alternatively, an obstacle avoidance system 158 may use data from the obstacle detection system 156 to create one or more alternative paths around obstacles detected by the obstacle detection system 156.

In this example, the obstacle detection 156 and the obstacle avoidance system 158 may be part of the vehicle control unit 150. Alternatively, either or both the obstacle detection system 156 and the obstacle avoidance system 158 may not be part of the vehicle control unit 150. The obstacle detection system 156 and/or the obstacle avoidance system 158 may comprise separate controllers that communicate with vehicle control unit 150 and/or the sensor array 179 and/or the steering control system 144 and/or speed control system 146.

The vehicle control unit 150 may be communicatively coupled with the steering control system 144, the speed control system 146, the implement control system 148, and the obstacle detection system 156. The vehicle control unit 150, for example, may include any or all the components shown in FIG. 6. The vehicle control unit 150, for example, may be integrated into a single controller or may include a plurality of distinct components or controllers. The vehicle control unit 150 may be coupled with one or more sensors from the sensor array 179 and receive sensor data from the sensor array 179. The obstacle detection system 156 may be coupled with one or more sensors from the sensor array 179 and may directly receive sensor data from the sensor array 179. In other examples, the obstacle detection system 156 may be indirectly coupled to the sensor array 179, such as via the vehicle control unit 150.

The vehicle control unit 150, for example, may be used to control various aspects of the vehicle such as, for example, sending instructions to the steering control system 144, implement control system 148, speed control system 146, obstacle detection system 156, etc. The vehicle control unit 150, for example, may include a vehicle artificial intelligence (VAI) that may include one or more processors that execute one or more algorithms.

The vehicle control unit 150, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, obstacle detection, manual inputs from a user, and the like, or any combination thereof. These signals, for example, may come from the sensor array 179, from the obstacle detection system 156, or from base station 180.

The vehicle control unit 150, for example, may be an electronic controller with electrical circuitry configured to process data from the various components of the autonomous vehicle 110. The vehicle control unit 150 may include any or all of the components shown in FIG. 6, such as the processor 610, and a working memory 635. The vehicle control unit 150 may also include one or more storage devices and/or other suitable components of computational system 600. The processor may be used to execute software, such as software for calculating drivable path plans or may be used to execute an obstacle confirmation subsystem to determine whether the obstacle detection system 156 should be overridden. Moreover, the processor may include multiple microprocessors, one or more “general-purpose” microprocessors, one or more special-purpose microprocessors, and/or one or more application specific integrated circuits (ASICS), or any combination thereof. For example, the processor 154 may include one or more reduced instruction set (RISC) processors.

The vehicle control unit 150, for example, may include a volatile memory, such as random-access memory (RAM), and/or a non-volatile memory, such as ROM (e.g., working memory 635 and/or storage device 625). The memory may store a variety of information and may be used for various purposes. For example, the memory may store processor-executable instructions (e.g., firmware or software) for the vehicle control unit 150 to execute, such as instructions for calculating drivable path plan, and/or controlling the autonomous vehicle 110. The memory may include flash memory, one or more hard drives, or any other suitable optical, magnetic, or solid-state storage medium, or a combination thereof. The memory may store data such as field maps, maps of desired paths, vehicle characteristics, software or firmware instructions and/or any other suitable data.

The steering control system 144, for example, may include a curvature rate control system 160, a differential braking system 162, a steering mechanism, and a torque vectoring system 164 that may be used to steer the autonomous vehicle 110. The curvature rate control system 160, for example, may control a direction of an autonomous vehicle 110 by controlling a steering control system of the autonomous vehicle 110 with a curvature rate, such as an Ackerman style autonomous vehicle, 110 or articulating vehicle. The curvature rate control system 160, for example, may automatically rotate one or more wheels or tracks of the autonomous vehicle 110 via hydraulic or electric actuators to steer the autonomous vehicle 110. By way of example, the curvature rate control system 160 may rotate front wheels/tracks, rear wheels/tracks, and/or intermediate wheels/tracks of the autonomous vehicle 110 or articulate the frame of the vehicle, either individually or in groups. The differential braking system 162 may independently vary the braking force on each lateral side of the autonomous vehicle 110 to direct the autonomous vehicle 110. Similarly, the torque vectoring system 164 may differentially apply torque from the engine to the wheels and/or tracks on each lateral side of the autonomous vehicle 110. While the illustrated steering control system 144 includes the curvature rate control system 160, the differential braking system 162, and the torque vectoring system 164, the steering control system 144 may include one or more of these systems. Further examples may include a steering control system 144 having other and/or additional systems to facilitate turning the autonomous vehicle 110 such as an articulated steering control system, a differential drive system, and the like.

The speed control system 146, for example, may include an engine output control system 166, a transmission control system 168, and a braking control system 170. The engine output control system 166 may vary the output of the engine to control the speed of the autonomous vehicle 110. For example, the engine output control system 166 may vary a throttle setting of the engine, a fuel/air mixture of the engine, a timing of the engine, and/or other suitable engine parameters to control engine output. In addition, the transmission control system 168 may adjust gear selection within a transmission to control the speed of the autonomous vehicle 110. Furthermore, the braking control system 170 may adjust braking force to control the speed of the autonomous vehicle 110. While the illustrated speed control system 146 includes the engine output control system 166, the transmission control system 168, and the braking control system 170, the speed control system 146 may include one or two of these systems. The speed control system 146, for example, may also include other systems and/or additional systems that may be used to control the speed of the autonomous vehicle 110.

The implement control system 148, for example, may control various parameters of the implement towed by and/or integrated within the autonomous vehicle 110. For example, the implement control system 148 may instruct an implement controller via a communication link, such as a CAN bus, ISOBUS, Ethernet, wireless communications, and/or Broad R Reach type Automotive Ethernet, etc.

The implement control system 148, for example, may instruct an implement controller to adjust a penetration depth of at least one ground engaging tool of an agricultural implement.

The implement control system 148, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc.

The implement control system 148, as another example, may instruct the implement controller to adjust a shovel height, a shovel angle, a shovel position, etc.

The obstacle detection system 156 may be configured to receive data from the sensor array 179 including, for example, visual data from cameras disposed on the autonomous vehicle 110, or any other sensor data from any other sensors. The cameras may include front-facing cameras to provide visual data of the front and/or front-sides of the autonomous vehicle 110, rear-facing cameras to provide visual data of the rear and/or rear sides of the autonomous vehicle 110 and/or internal cameras to provide visual data of the interior of the autonomous vehicle 110, such as an operator seat.

The obstacle detection system 156 may detect obstacles in the vicinity of the autonomous vehicle 110, and if an obstacle is detected, send an inhibit signal to the vehicle control unit 150 to inhibit movement or start-up of the autonomous vehicle 110 or to shut down the autonomous vehicle 110. This reduces the likelihood of collisions with obstacles including people, thereby increasing the safety of the autonomous vehicle 110. The obstacle detection system 156 may use sensor data from multiple different sensors to determine the presence of an obstacle, or to distinguish between different types of obstacles.

The obstacle detection system 156 may comprise a cascade classifier or deep learning algorithm for detecting and/or distinguishing between obstacles.

An operator interface 152, for example, may be communicatively coupled to the vehicle control unit 150 and/or the obstacle detection system 156 and configured to present data from the autonomous vehicle 110 via a display. Display data may include data associated with operation of the autonomous vehicle 110, data associated with operation of an implement, a position of the autonomous vehicle 110, a speed of the autonomous vehicle 110, a desired path, a drivable path plan, a target position, a current position, visual data from cameras of the area surrounding the autonomous vehicle 110 or within the autonomous vehicle etc. The operator interface 152 may enable an operator to control certain functions of the autonomous vehicle 110 such as starting and stopping the autonomous vehicle 110, inputting a desired path, etc. The operator interface 152, for example, may enable the operator to input parameters that cause the vehicle control unit 150 to adjust the drivable path plan. For example, the operator may provide an input requesting that the desired path be acquired as quickly as possible, that an off-path normal error be minimized, that a speed of the autonomous vehicle 110 remain within certain limits, that a lateral acceleration experienced by the autonomous vehicle 110 remain within certain limits, etc. In addition, the operator interface 152 (e.g., via the display, or via an audio system (not shown), etc.) may alert an operator if the desired path cannot be achieved, for example. The operator interface 152, for example, may also alert the operator that an obstacle has been detected by the obstacle detection system 156 and/or may enable the operator to confirm or negate the presence of an obstacle when viewing visual data from cameras on the operator interface 152.

The vehicle control unit 150, for example, may include a base station 180 having a base station controller 184 located remotely from the autonomous vehicle 110. For example, the control functions of the vehicle control unit 150 may be distributed between the vehicle control unit 150 of the autonomous vehicle 110 and the base station controller 184. The base station controller 184, for example, may perform a substantial portion of the control functions of the vehicle control unit 150. For example, a first transceiver 178 positioned on the autonomous vehicle 110 may output signals indicative of vehicle characteristics (e.g., position, speed, heading, curvature rate, curvature rate limits, maximum turning rate, minimum turning radius, steering angle, roll, pitch, rotational rates, acceleration, obstacle detection in the vicinity of the vehicle etc.) to a second transceiver 186 at the base station 180. The base station controller 184, for example, may calculate drivable path plans and/or output control signals to control the curvature rate control system 160, the speed control system 146, and/or the implement control system 148 to direct the autonomous vehicle 110 toward the desired path, for example. The base station controller 184 may include a processor and memory device having similar features and/or capabilities as the processor and the memory device discussed previously. Likewise, the base station 180 may include an operator interface 182 having a display, which may have similar features and/or capabilities as the operator interface 152 and the display discussed previously.

In some embodiments, the base station 180 and/or the autonomous vehicle 110 may be in communication with a user device 190. A user device may include a phone, tablet, laptop, or computer. The user device 190, for example, can include an application is executable by a controller 194 that allows the user to interact with the communication and control system 100 via a user interface 192. The user device 190 may communicate commands to the autonomous vehicle 110 and/or receive information about the autonomous vehicle 110 via transceiver 196 and/or the user device 190 may communicate commands with the base station 180 and/or receive information from the base station 180 via transceiver 196. Alternatively, or additionally, the user device 190, for example, can include an application that allows the user to observe the autonomous vehicle 110 move through a map of the work area where the autonomous vehicle operates. Alternatively, or additionally, the user device 190, for example, can provide images from one or more sensors of the sensor array 179.

The user device 190, for example, may include an application that can display any of the information disclosed in this document, such as visual data from cameras on the autonomous vehicle 110, and any inputs provided by the obstacle detection system 156. The user device 190 may be configured to prompt an operator for commands, and to receive commands from the operator to control the autonomous vehicle 110.

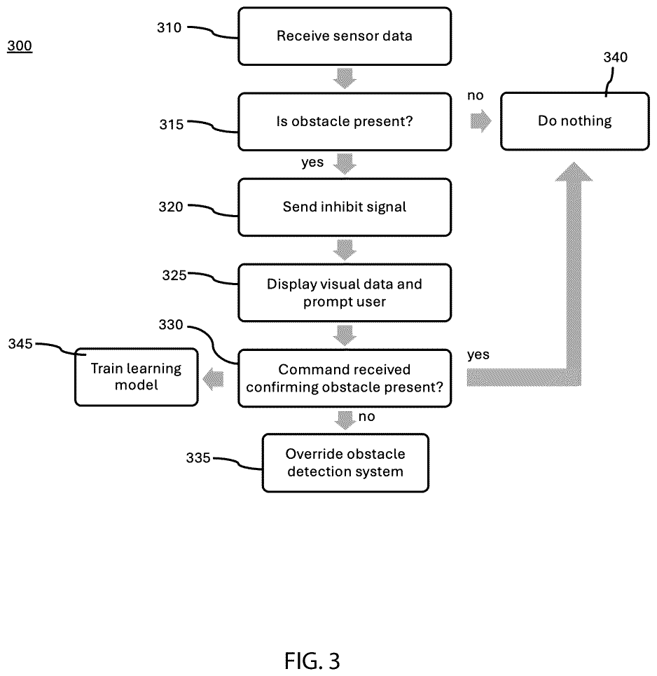

FIG. 3 is a flow chart of an example process 300 for controlling an autonomous vehicle (e.g., autonomous yard truck 105, autonomous tractor 400, autonomous mower 500, etc.) with an obstacle detection system (e.g., obstacle detection system 156). Process 300 may be executed in part by an obstacle confirmation subsystem, which may include the vehicle control unit 150 or another controller and/or the obstacle detection system 156.

Process 300 starts at block 310. At block 310, the obstacle detection system 156 may receive sensor data from the sensor array 179. The sensor data may include any data with which the obstacle detection system 156 may be able to determine the presence of an obstacle in the sensor field of view, such as cameras, infrared sensors, Lidar sensors, radar sensors, sonar sensors etc. The sensor data may include visual data which may be received from a camera system within the sensor array 179 including, for example, a front-facing camera, a rear-facing camera and/or an internal camera. In some examples, the visual data may be received from different sources depending on the direction of travel or intended direction of travel of the autonomous vehicle 110.

At block 315, the obstacle detection system 156 may determine whether an obstacle is present based on the sensor data, which may include the visual data. The obstacle detection system 156 may use any suitable means to determine the presence of an obstacle. For example, the obstacle detection system 156 may use a deep learning algorithm or a cascade classifier. The obstacle detection system 156 may divide the sensor data representing a field of view of the sensor array 179 into an occupancy grid. If an obstacle is detected within any cells in the occupancy grid, the respective cells representing the area in which an obstacle was detected within the occupancy grid may be identified as comprising an obstacle. In some examples, the obstacle detection system 156 may distinguish between different detected obstacles and may store the detected obstacles in an object list. The obstacle detection system 156 may distinguish between obstacles in the form and people and animals, and any other objects, and may only determine that an obstacle is present when a person or animal is detected. If an obstacle is detected by the obstacle detection system 156, process 300 may proceed to block 320. If no obstacle is detected, process 300 may proceed to block 340. At block 340, the obstacle detection system 156 may do nothing, and process 300 may return to block 310.

At block 320, a determination has been made that an obstacle is present, and therefore the obstacle detection system 156 may send an inhibit signal to the vehicle control unit 150 to inhibit movement or start-up of the autonomous vehicle 110 or to shut down the autonomous vehicle 110.

At block 325, the obstacle confirmation subsystem may send visual data to a user interface, such as the operator interface 152 on the autonomous vehicle 110, the operator interface 182 on the base station 180, or the user interface 192 on a separate device 190. The visual data may be accompanied with a time stamp of when the visual data was taken, and the obstacle confirmation subsystem may review the time stamp against a threshold time, before sending it to the user interface, to ensure that the visual data is not too old to be used. If the visual data is determined to be too old, the obstacle confirmation subsystem may send a request for new visual data, and may return to block 310, or may send the new visual data directly to the user interface without returning to block 310. Where the obstacle detection system 156 has divided the area represented by the sensor data into an occupancy grid, the occupancy grid may be overlaid on the user interface showing the visual data to the operator, and cells in which obstacles have been detected may be highlighted on the user interface to aid the operator in identifying the obstacles. At block 325, the obstacle confirmation subsystem may also prompt an operator, through the user interface, to confirm or negate the presence of an obstacle. In other examples, the operator may be able to choose of their own volition to confirm or negate the presence of an obstacle. Where the obstacle detection system 156 has stored an object list with detected obstacles, the object list may be presented to the user on the user interface to aid the user in identifying the detected obstacles. The user may also be given the option, on the user interface, to identify that the image is not of usable quality to make a determination.

At block 330, the obstacle confirmation subsystem may receive a command from the operator through the user interface, either confirming or negating the presence of the obstacle. If a command is received confirming the presence of the obstacle, process 300 may proceed to block 340. If a command is received negating the presence of an obstacle, process 300 may proceed to block 335. In either event, process 300 may simultaneously proceed to block 345.

In block 335, the obstacle confirmation subsystem may send a signal to the vehicle control unit 150 to override the inhibit signal from the obstacle detection system 156 which would enable movement or start-up of the autonomous vehicle 110. Where the obstacle detection system 156 has divided an area into an occupancy grid, overriding the inhibit signal from the obstacle detection system 156 may include clearing the occupancy grid, such that the obstacle detection system 156 stops sending the inhibit signal. Where the obstacle detection system 156 has stored an object list with detected obstacles, overriding the inhibit signal from the obstacle detection system 156 may include clearing the object list.

In block 345, the obstacle confirmation subsystem may send the sensor data, including for example the visual data, and the command to a learning model to train the learning model.

The order of the various blocks in process 300 can occur in any order. Additionally, or alternatively, one or more blocks may be skipped, one or more blocks may be performed in parallel, and/or one or more blocks may be combined, and/or one or more blocks may be performed in any number of sub-blocks.

Using process 300 to confirm obstacle detection by the obstacle detection system 156 may be useful in scenarios of false positive detection, where sending an image to the operator allows the operator to have proper context to intervene and override the obstacle detection system 156. Sometimes, the identification of obstacles by the obstacle detection system 156 may be as a result of an operator moving from an operator seat on the autonomous vehicle 110, through the field of view of detection sensors, and the sensors may report an obstacle in the occupancy grid that persists longer than the person is actually present. Process 300 enables the operator to assess the safety of the areas around the vehicle to reset the system without doing a complete restart of the system.

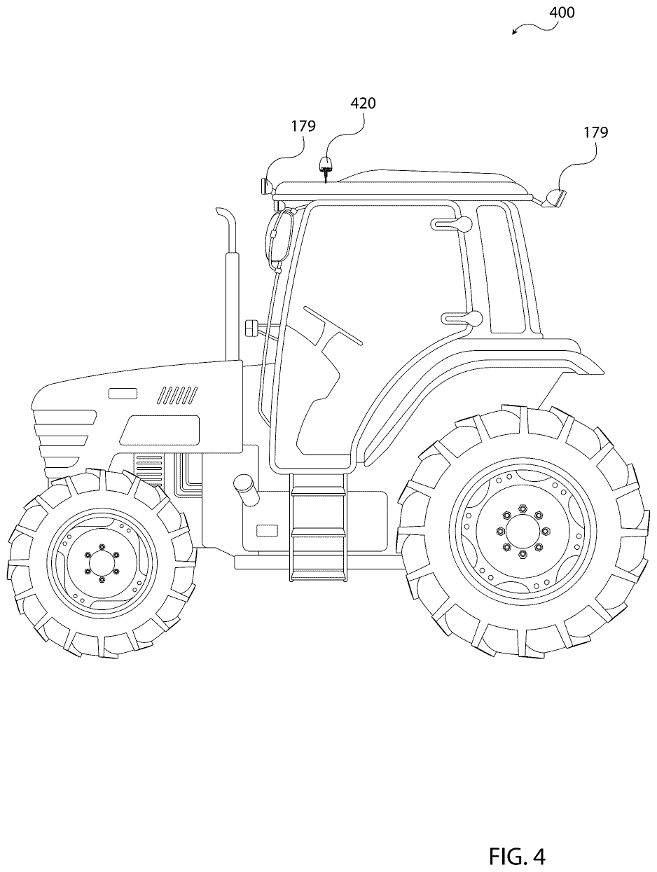

FIG. 4 is a sideview of an example autonomous tractor 400, which may include all or some of the components of autonomous vehicle 110. The autonomous vehicle in this document may include the autonomous tractor 400. In this example, the autonomous tractor 400 may include standard tractor equipment and/or components. The autonomous tractor 400 may include or be coupled with any kind of implement such as, for example, plow, disc plow, reel mower, dumper, lift, bucket, shovel, blade, cutter, etc. The autonomous tractor 400, for example, includes a sensor array 179 (or multiple sensor arrays). The sensor array 179 may include, for example, one or more lidar, radar, and/or video cameras. The video cameras, for example, may include 360 degree cameras, a front facing camera, and/or a back facing camera.

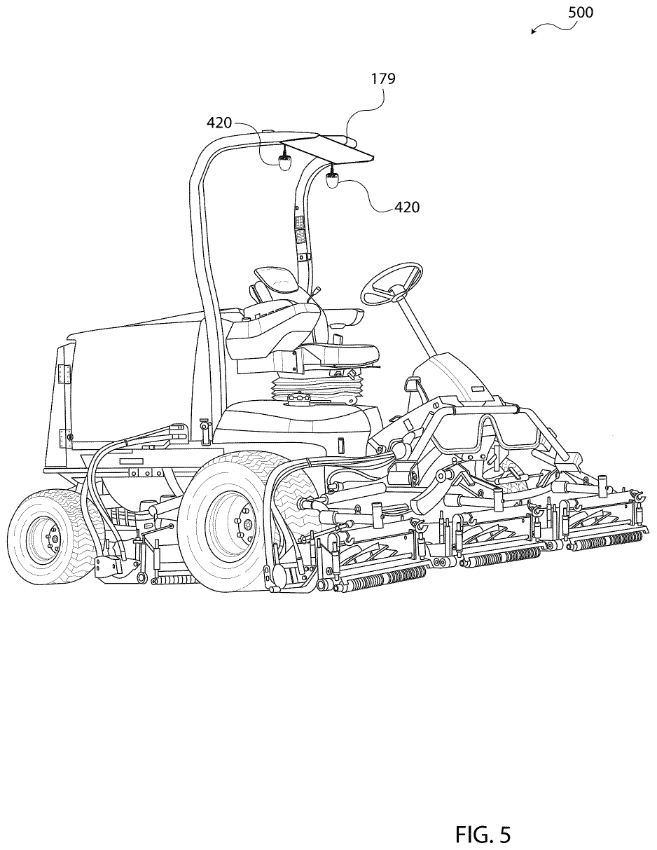

FIG. 5 is a sideview of an example autonomous mower 500, which may include all or some of the components of autonomous vehicle 110. The autonomous vehicle in this document may include the autonomous mower 500. In this example, the autonomous mower 500 includes a disc mower 545. Any type of mower or blades may be used instead of the disc mower. The autonomous mower 500, for example, includes a sensor array 179 (or multiple sensor arrays). The sensor array 179 may include, for example, one or more lidar, radar, and/or video cameras. The video cameras, for example, may include 360 degree cameras, a front facing camera, and/or a back facing camera.

The computational system 600, shown in FIG. 6 can be used to perform any of the examples disclosed in this document. For example, computational system 600 can be used to execute process 300. As another example, computational system 600 can perform any calculation, identification and/or determination described here. Computational system 600 includes hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 600 might also include a communications subsystem 630, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 630 may permit data to be exchanged with a network (such as the network described below, to name one example), and/or any other devices described in this document. The computational system 600, for example, may include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

The storage medium, for example, might be incorporated within the computational system 600 or in communication with the computational system 600. The storage medium might be separate from a computational system 600 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

Although term “autonomous vehicle” includes manned vehicles, remote control vehicles, manual vehicles, etc.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples disclosed in this document. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied, for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific examples, those skilled in the art, upon attaining an understanding of these examples, may readily produce alterations to, variations of, and equivalents to such examples. Accordingly, the present disclosure has been presented for purposes of example rather than limitation, and does not preclude inclusion of such modifications, variations and/or additions to the present subject matter as would be readily apparent to one of ordinary skill in the art.

That which is claimed:

1. An autonomous vehicle comprising:
a sensor array including a camera system;
an obstacle detection system configured to receive sensor data from the sensor array,
a user interface configured to receive visual data from the camera system and to display the visual data from the camera system to an operator,
wherein the obstacle detection system is further configured to:
detect the presence of an obstacle based on the sensor data, and
send out an inhibit signal to inhibit movement or start-up of the autonomous vehicle or to shut down the autonomous vehicle when an obstacle is detected;
the autonomous vehicle further comprising a controller, in communication with the obstacle detection system and the user interface, the controller configured to:
receive commands from an operator identifying or negating the presence of an obstacle;
if the controller receives a command negating the presence of an obstacle, overriding the obstacle detection system and enabling movement of the autonomous vehicle.

2. The autonomous vehicle according to claim 1, wherein the controller is configured to prompt the operator, through the user interface, to identify or negate the presence of an obstacle, if an obstacle is detected by the obstacle detection system.

3. The autonomous vehicle according to claim 1, if the controller receives a command identifying the presence of an obstacle, taking no action.

4. The autonomous vehicle according to claim 1, if the controller receives a command identifying or negating the presence of an obstacle, using the received command to train a learning model in the obstacle detection system.

5. The autonomous vehicle according to claim 1, wherein the obstacle detection system is configured to divide the sensor data representing a field of view of the sensor array into an occupancy grid such that, if an obstacle is detected, respective cells representing the area in which an obstacle was detected within the occupancy grid are identified as comprising an obstacle.

6. The autonomous vehicle according to claim 5, wherein the occupancy grid is overlaid on the user interface and the respective cells identified as comprising the obstacle are highlighted on the user interface to aid the user in identifying the obstacle.

7. The autonomous vehicle according to claim 5, wherein overriding the obstacle detection system comprises clearing the occupancy grid.

8. The autonomous vehicle according to claim 1, wherein the obstacle detection system is configured to represent obstacles found in an object list, which is presented to the user on the user interface.

9. The autonomous vehicle according to claim 8, wherein overriding the obstacle detection system comprises clearing the object list.

10. The autonomous vehicle according to claim 1, wherein the autonomous vehicle is a mower, a yard truck, a loader, a wheel loader, a track loader, a dump truck, a digger, a backhoe, a forklift, a harvester, a tractor, a land leveler, a scraper, a dozer, a trencher, a grader, a seeder, a fertilizer, or a harrow.

11. A method of controlling an autonomous vehicle, the method comprising:
receiving sensor data from a sensor array on the autonomous vehicle, including visual data from a camera system;
detecting the presence of an obstacle based on the sensor data with an obstacle detection algorithm;
sending out an inhibit signal to inhibit movement or start-up of the autonomous vehicle or to shut down the autonomous vehicle when an obstacle is detected;
displaying the visual data to an operator;
receive commands from an operator identifying or negating the presence of an obstacle; and
if a command negating the presence of an obstacle is received, overriding the obstacle detection algorithm to enable movement of the autonomous vehicle.

12. The method according to claim 11, comprising, when the obstacle is detected, prompting a user to identify or negate the presence of the obstacle.

13. The method according to claim 11, comprising, if a command identifying the presence of an obstacle is received, taking no further action.

14. The method according to claim 11, comprising, if a command identifying or negating the presence of an obstacle is received, using the received command to train a learning model in the obstacle detection algorithm for detecting the obstacles.

15. The method according to claim 11, wherein sensor data is represented in an occupancy grid such that, if an obstacle is detected, respective cells representing the area in which an obstacle is detected within the occupancy grid are identified as comprising an obstacle.

16. The method according to claim 15, comprising overlaying the occupancy grid on the user interface and highlighting the respective cells determined to comprise an obstacle on the user interface to aid the user in identifying the obstacle.

17. The method according to claim 15, wherein overriding the obstacle detection algorithm comprises clearing the occupancy grid.

18. The method according to claim 11, wherein obstacle detection is represented to the user as an object list, if an obstacle is detected, to aid the operator in identifying the obstacles.

19. The method according to claim 18, wherein overriding the obstacle detection algorithm comprises clearing the object list.

20. The method according to claim 13, wherein the autonomous vehicle is a mower, a yard truck, a loader, a wheel loader, a track loader, a dump truck, a digger, a backhoe, a forklift, a harvester, a tractor, a land leveler, a scraper, a dozer, a trencher, a grader, a seeder, a fertilizer, or a harrow.

21. An autonomous vehicle comprising:
a sensor array including a camera system;
an obstacle detection system configured to receive sensor data from the sensor array and to divide the sensor data representing a field of view of the sensor array into an occupancy grid such that, if an obstacle is detected within the field of view, respective cells representing the area in which an obstacle was detected within the occupancy grid are identified as comprising an obstacle,
a user interface configured to receive visual data from the camera system and to display the visual data from the camera system to an operator,
wherein the obstacle detection system is further configured to:
detect the presence of an obstacle within the occupancy grid based on the sensor data, and
send out an inhibit signal to inhibit movement or start-up of the autonomous vehicle or to shut down the autonomous vehicle when an obstacle is detected;
the autonomous vehicle further comprising a controller, in communication with the obstacle detection system and the user interface, the controller configured to:
prompt the operator, through the user interface, to identify or negate the presence of an obstacle, if an obstacle is detected by the obstacle detection system;
receive commands from an operator identifying or negating the presence of an obstacle;
if the controller receives a command negating the presence of an obstacle, overriding the obstacle detection system, by clearing the occupancy grid, and enabling movement of the autonomous vehicle.
